(19) United States
(12) Patent Application Publication
(10) Pub. No.: US 2004/0182328 A1
(43) Pub. Date: Sep. 23, 2004

(54) Bite arrangement for pigs

(76) Inventor: Bjarne Kongsgaard, Silkeborg (DK)

Correspondence Address: James C Wray, Suite 300, 1493 Chain Bridge Road, McLean, VA, 22101, US

(21) Appl. No.: 10/480,303

(22) PCT Filed: May 27, 2002
(86) PCT No.: PCT/DK02/00358

(30) Foreign Application Priority Data
May 28, 2001 (DK) PA 2001 00849

(51) Int. Cl. A01K 29/00

(52) U.S. Cl. 119/707

(57) ABSTRACT

A bite device for pigs for counteracting tail biting is made so that rods (1) for biting are disposed annularly along the periphery of a support (4), which may be conical. Thereby, separation of the rods (1) is achieved so that they are more easily accessed by the pigs. The support (4) may furthermore be used as a holder for a block of mineral supplement for the pig's feed.

### BACKGROUND OF THE INVENTION

The present invention concerns a bile device for pigs and including a support carrying a number of oblong bite objects in the form of rods of tough plastic material projecting from the support and used by the pigs to find outlet for an urge that otherwise may be manifested in tail biting.

Such bite devices are prior am for use in raising porkers right from piglets. The prior art devices consist of a ring hanging in a vertical plane, and where the bite objects in the form of rods of tough plastic material are hanging loosely on the ring at one end of them, almost as keys in a key ring. Thereby, the pigs may bite in the rods and find outlet for an urge that otherwise may be manifested in tail biting. Tail biting often causes infection in the pigs and consequently loss, since flesh from animals having or previously having had infection has to be discarded. Thus, if tail biting can be reduced, considerable savings in the fad economy may be attained.

It is important for the action of the bite device tat the pigs find the objects interesting as rummaging toys or bite objects. The bite objects have to be exchangeable when they are worn out. The objects may not lie on the floor in the pigsty since they then become dirty and thereby uninteresting for the pigs. Therefore, the bite objects are suspended, and it is important that the object has great mobility, i.e. ability to swing. In the prior art devices there is a certain mobility, namely transverse of the ring plane. As the rods slide together on the ring when in use, there is only little mobility of the rods in the plane of the ring. Furthermore, the mutual position of the rods on the ring provides that only one or two pigs have access to the rods at a time.

Furthermore, it is acknowledged that the animals have need for feed supplement, preferably minerals. As such feed supplements are formed of material with inferior coherence, they are often given to the animals as pills or as large blocks suspended in the sty.

It is the purpose of the invention to indicate a bite device which is not only interesting for the animals as toy but also enables a plurality of pigs to use the same bite device and which simultaneously can be used for giving a feed supplement to the animals, preferably minerals.

### EXPLANATION OF THE INVENTION

The peculiar features of the bite device according to the invention is that the support is arranged with a flexible mounting means for movement in relation to the point of fastening on ceiling, wall and floor, and that the support is arranged so that the bite objects are mounted at points along a horizontally extending circle.

Due to the mounting along a circle, the bite objects can be suspended at greater distance from each other, and with free mobility of the support of the bite objects in relation to points of fastening this provide for greater interest on the part of the pigs. Furthermore, it is possible that more pigs can use the same bite device than by the prior art.

The mounting means can be a wire or chain, whereby the mobility appears as free oscillation. The mounting means may also include spring elements, whereby the mobility becomes resiliently yielding. This is particularly an advantage by mounting on wall or on floor.

By mounting on wall or floor, the arrangement may be peculiar in that the support includes a curved surface for bearing against wall or floor, and that the resilient element holds the support in resilient abutment against said wall or floor. Hereby is ensured that the device keeps a desired orientation in relation to the wall or the floor so that the animals have free access to the bite objects. Also, it is ensured that a floor mounted support will not lie down and imply the risk of bite objects being dirtied and becoming uninteresting for the animals.

In a simple embodiment of the invention, the points of mounting of respective bite objects are mutually spaced along a ring which may be suspended in horizontal position.

In a further embodiment, the external shape of the support is a cone pointing downwards in suspended condition, the bite objects projecting inclining from the side of the cone. Hereby, large separation between the bite objects is achieved, and the side of the support appears as a wall providing reduced possibility for the pigs' getting hold of the support itself and maybe tearing it down.

In a further embodiment of the invention, the support is made cylindric and the bite objects are suspended at the lowermost rim of the support during use. In a simple and cheap form, the support may be a tube with suitable diameter.

By a partly closed construction of the support, the arrangement in a further embodiment according to the invention may be arranged with the interior of the support being provided with a moulded core of feed supplement for pigs, and where the side of the support is perforated so that pigs have access to the feed supplement and may eat it, and that the bite objects at least partly are made of feed supplement, preferably minerals. Since the pigs are to have supplement anyway, e.g. in the form of minerals, it is advantageous to use the support of the bite device as dispenser for this. Thereby space is saved in the pigsty, and use of other means for placing the minerals are avoided. Hereby, both the interior of the support and the bite objects may be used for giving feed supplement. Same or different feed supplements may be given.

It is preferred that each bite object is rod-shaped and provided with at least one longitudinal slit and with an annular groove along its periphery close to one end thereof. Thereby is achieved a readily exchanged bite object fixed by engagement between groove and a hole in a plate piece on the support, though without being prevented from the swinging movement. The bite object may thereby be squeezed together around the groove for reducing the cross-section by mounting in an aperture in the support.

For achieving a particularly good resiliency and thereby easy exchange, it is preferred that the rod-shaped bite object consists of a substantially S-shaped profile.

According to a further embodiment, the bite device according to the invention can be formed with a support including a central column mounted on a base plate, which can be fastened in the floor, on which is disposed one or more tubes that may be utilised as dispenser for mineral pills, mineral rods, straw briquettes or feed. Under each tube there will thus be a bowl for stuffing/containing pills/briquettes or for supporting a rod extending through the tube. The tube, or each of the tubes, is fastened to the column via flexible fittings. These fittings may e.g. comprise spring steel whereby the tubes are fastened to the column. At a suitable level on the tubes there are mounted bite objects which are fitted extending under different angles into space so that more animals may have access to these. With such embodiment of the bite device there is advantageously achieved a combined support/dispenser for the bite object, minerals and/or straw briquettes. If the column is disposed on a base plate, it may be disposed at an arbitrary place in a sty for forming free access around the column which may support one to four tubes.

Alternatively, each of the tubes may be fastened directly on the wall in a sty.

The tubes may be disposed at a fixed level or in the floor. Alternatively, the column may be provided by two telescoping columnar elements so that possibility of height adjustment of the tubes is achieved and thereby for the positioning of the bite objects and the bowls for supplying minerals/briquettes. Hereby, adaptation to pigs of different size may be effected with one and the same device.

According to a further embodiment, the bite device according to the invention is adapted so that it may be fastened on a partitioning between two adjacent sties. In such an embodiment, a tube is provided in a flexible support box which is mounted permanently in the wall. At each end of the tube, a ring with a number of bite objects extending outwards and away from the wall may be provided.

When pigs from one sty bite in the rod at one side of the wall, this will cause movement in the rod at the opposite side, whereby the bite device becomes more interesting for the animals in the adjacent sty.

In an alternative embodiment, a tube in which a chain is provided may be disposed through the partitioning wall between different sties. The chain is drawn through the tube and is provided with stop means, e.g. balls at each end of the tube, so that the pigs cannot draw the chain through the tube. Immediately under the ball, or associated with the ball itself, there is provided a holder, e.g. in the form of a tube fastened to the chain. Each of these holders may be provided with two to four bite objects which e.g. may be fastened to the holder, which alternatively can be detachably fastened by snap action, so that only bite objects/bite rods are exchanged by snapping a down-bitten object out from the holder and snapping in a new bite object. Such a bite object may e.g. be the S-shaped type as discussed in the following.

### DESCRIPTION OF THE DRAWING

Example embodiments of the invention will now be described in detail with reference to the drawing, where:

FIG. 1 shows a first embodiment of the bite device according to the invention in perspective view,

FIG. 2 and 3 show a second, preferred embodiment of the invention, seen from above in perspective view and as a vertical section, respectively,

FIG. 4 shows a third embodiment of the invention as seen from the side,

FIGS. 5-7 show three different versions of bite objects according to the invention,

FIG. 8 shows a detail of further embodiments of a bite object according to the invention,

FIG. 9 shows a side view of a farther embodiment of a bite device according to the invention intended for wall mounting and dispensers for feed supplement,

FIG. 10 shows a view of the bite device in FIG. 9 as seen from above,

FIG. 11 shows a view from above of a further embodiment of a bite device intended for mounting on the floor and which is intended for acting as dispenser for feed supplement,

FIG. 12 shows a side view of the bite device in FIG. 11,

FIGS. 13-14 show perspective views for illustrating mounting and dismounting, respectively, on a slatted floor of the bite device shown in FIGS. 11 and 12,

FIG. 15 shows a perspective view of a further embodiment for a bite device according to the invention arranged with a combined dispenser for minerals, straw briquettes or feed,

FIG. 16 shows a side view of a further embodiment for a bite device according to the invention intended for placing in a partitioning wall between two sties, and

FIG. 17 shows a perspective view of a further embodiment for a bite device according to the invention.

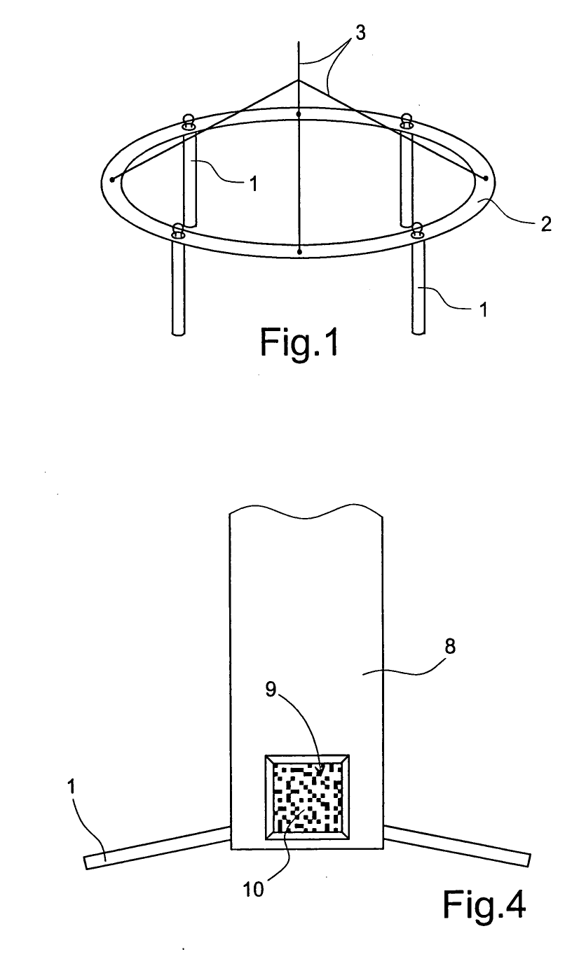

### DESCRIPTION OF EXAMPLE EMBODIMENTS

In the shown embodiments of the invention there are used rods 1 of TPU (thermoplastic polyurethane) as bite objects, but other types, both of shape and choice of material, are possible within the frames of the invention.

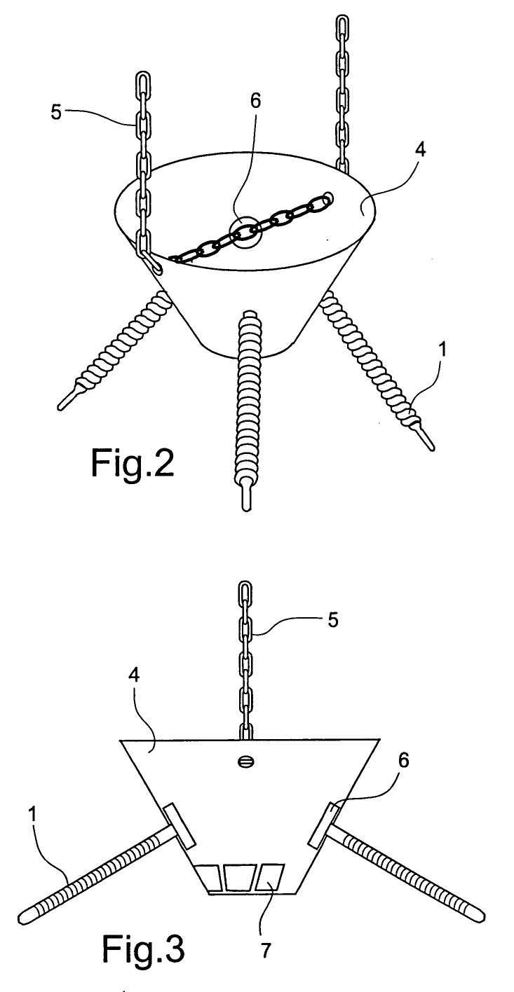

In order to make the rods 1 more attractive as bite object, they may be fluted or with thread-like exterior as shown on FIG. 2. There are depicted two or four bite objects for each arrangement; in other embodiments, the number may vary between three and eight.

In its simplest embodiment, the bite device may consist of a ring 2 of plastic or metal which are hanging down by wires 3 from a ceiling or equipment in a not shown pigsty. The rods 1 are loosely suspended on the ring 2 at mounting holes so that they may swing about the shown equilibrium where they 1 hang down vertically. This is a simple embodiment, and large spacing between rods 1 is provided, so that several pigs may access the rods 1 simultaneously.

In the second embodiment shown on FIGS. 2-3, the bite device consists of a conical support 4 hanging down from a chain 5. With not shown locks 6 at the inner side of the cone, or preferably as described below, the rods 1 are fastened pivotable on the support 4. Due to the cone shape, the rods 1 may be brought to project radially inclining downwards, as shown. A particularly good separation of the bite objects is thereby achieved, and simultaneously, in case of rods 1 as shown, these have an angle facilitating that the pigs catch them. The external cone surface on the support 4 forms a smooth and repelling face in relation to the body and snout movements of the pigs. The conical support 4 has apertures 7 at the bottom allowing dirt to fall down and thus not be collected in the support. The conical support 4 may have its greatest diameter of about 35 cm, which normally will be sufficient for the pigs to reach all rods 1. Other dimensions are of course possible.

In a third embodiment, the support can have cylindric shape as shown on FIG. 4. In a simple way, the support may be provided in the form of a tube 8, which has been cut with lateral holes for receiving the rods 1, so that they, as shown, protrude almost horizontally from the side of the tube 8, but still so that they 1 are movable when touched. In this embodiment there is also shown a lateral opening 9 in the tube 8, where the pigs can get access to a core 10 which is a moulded block of mineral feed supplement. The pigs may then lick minerals without using other measures. The tube 8 thus functions both as holder for bite objects and for feed supplement.

The core 10 may be a separate bloc, and the tube then acts as dispenser for this block. Alternatively, the core 10 is moulded directly into the tube 8, as the opening 9 is covered by a not shown element to tear off, which is just a part of the tube 8 but delimited by weakening lines which may readily be broken manually.

Having a moulded block of minerals in a bite device according to the invention may also be combined with the second embodiment on FIGS. 2-3. Here, the mineral block is just placed at the bottom of the lower part of the cone, and apertures as shown by 7, or other apertures in the side, may provide access to the feed supplement. The embodiment may be varied by direct moulding of core 10 as shown above in connection with the tube 8.

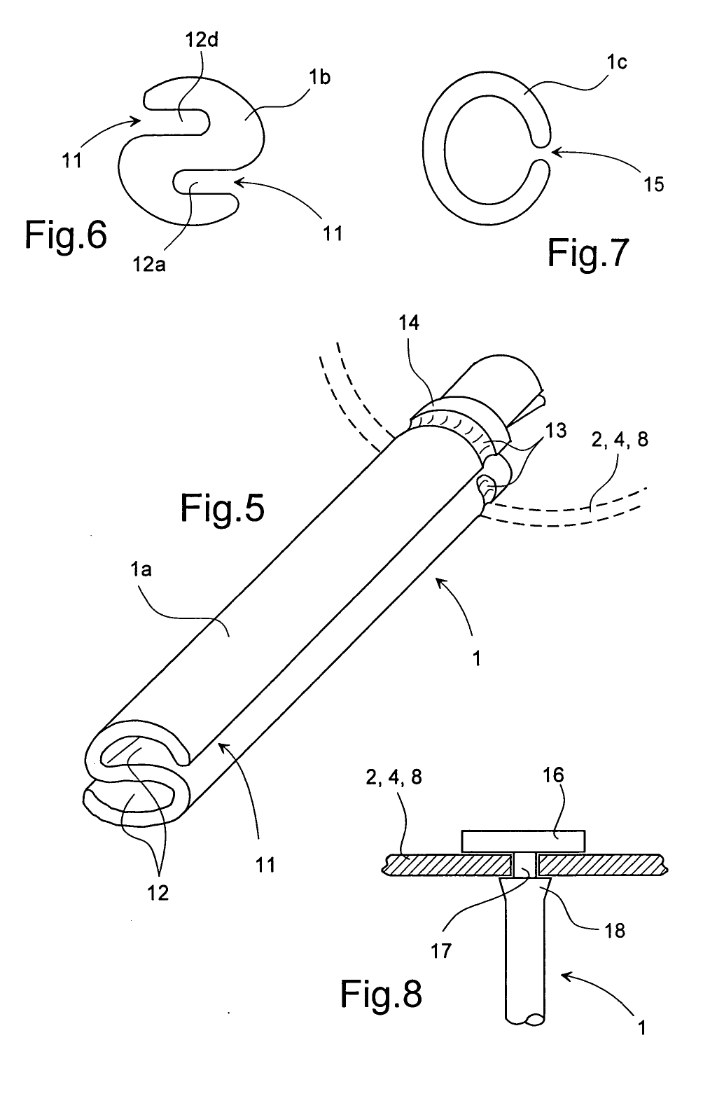

As shown on FIG. 5, a rod 1 may be made, e.g. moulded or extruded, as an S-shaped profile 1a, so that two longitudinal slits 11 are formed, and corresponding longitudinal cavities 12 in the rod 1. The cross dimension of the rod 1 may easily be reduced when it is to be mounted in a hole in a support 2,4,8. In order to ensure fastening in position in the support 2,4,8, the profile 1a is provided with an annular groove 13 at one end thereof, and which can engage the edge of the hole. In order to counteract pulling out of the rod 1 from the support 2,4,8 by the biting and pulling action of the pigs, the rod 1 may be provided with a bead 14 at the side of the groove 13 being closest to the internal end of the rod 1.

In a preferred embodiment of the rod 1, the S-shape is modified as shown on FIG. 6, where the slits 11 form cavities 12a with approximately parallel, opposite sides for injection moulding with mould cores that may be drawn out laterally of the finished items 1.

In a second, simpler version of the rod 1, it is made of an approximately C-shaped profile 1c with only one longitudinal slit 15 and correspondingly with one cavity as shown on FIG. 7.

In a second, preferred embodiment, the fastening at the support 2,4,8 may be as shown in FIG. 8. A narrowing 17 on the rod 1 is limited by a conical bead 18 and a discshaped brace (“lock”) 16 with relatively large diameter. Thereby, the rod 1 may be drawn through mounting holes in the support 2,4,8 as the bead 18 yield at the drawing through but where the brace 16 prevents complete pulling out of the rod 1 under the biting of the animals in the rod 1. Anyway, the bead 18 is not thicker than the rod 1 may be pressed back through its mounting hole when it 1 is worn and has to be exchanged.

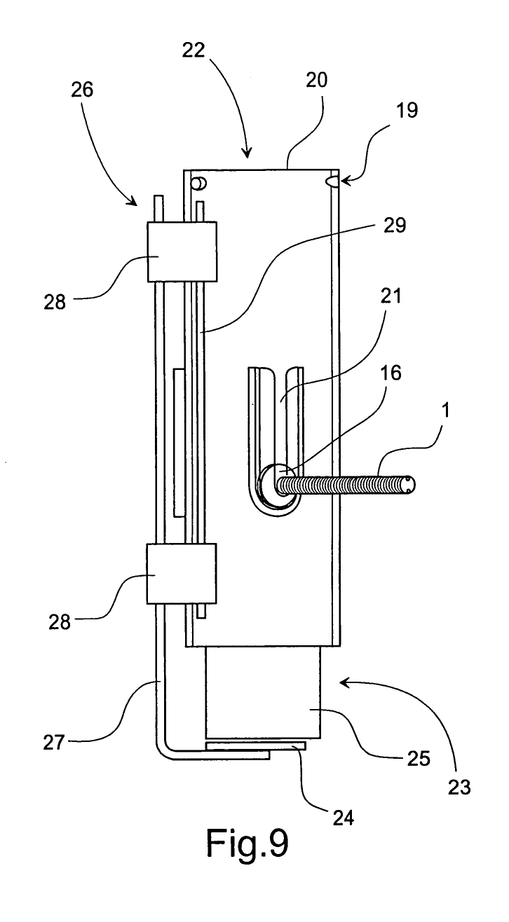

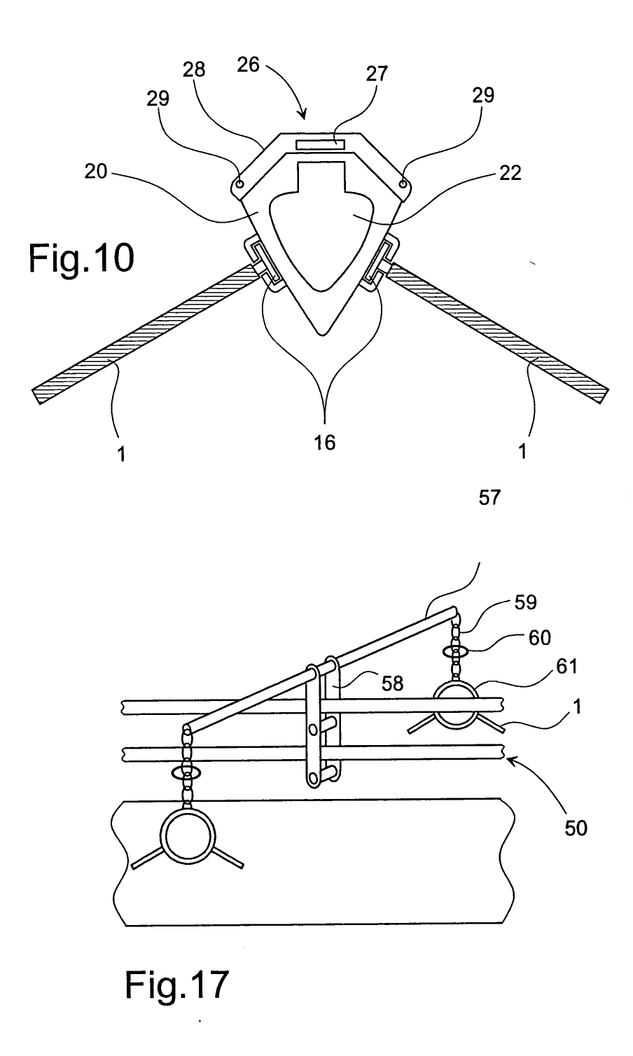

FIG. 9 illustrates a further embodiment of a bite device 19 according to the invention. The bite device 19 comprises a support 20. As it particularly appears from FIG. 10, this is largely triangular. At two sides, the support 20 is provided with U-shaped grooves 21 where a disc-shaped brace 18 is placed. This brace 16 will prevent the rod 1 from being pulled out of the groove 21 when the animals bite in the rod. The rod 1 is mounted by displacement through the groove 21. By making the groove 21 sufficiently long there is no risk of the animals lifting the rod free of the groove.

The support 20 includes a triangular tube with a hollow interior 22. The hollow interior is intended for receiving a rod 25 of feed supplement, e.g. minerals. This rod 25 will pass out below the support 20 and be exposed in an interspace 23, as the block rests on a support plate 24. The animals may thus eat the feed supplement in the rod 25 and simultaneously bite in the rods 1.

The support 20 is mounted on a wall via a suspension 26. The suspension 26 includes a rigid metal frame 27 of which a lower part is turned in for forming the support surface 24. At bottom and top there is provided a resilient U-shaped block 28, which encloses the frame 27, and which at the free ends of the U encloses metal rods 29 fastened to the support 20.

Due to the resiliency in the blocks 28, the support is flexibly movable with an elastic yielding ability relative to the fixed frame 27. Thus, in the construction is achieved a double mobility, as the bite rods 1 are movable by themselves.

Alternatively, the support 20 may be suspended in a frame for swinging or rotating about a vertical axis. The suspension will preferably be resiliently yielding. With this suspension is achieved a construction with double mobility, enhancing the pigs' interest for the bite device.

The unit shown in FIGS. 9 and 10 may thus be said to be a combined dispenser and bite rod support.

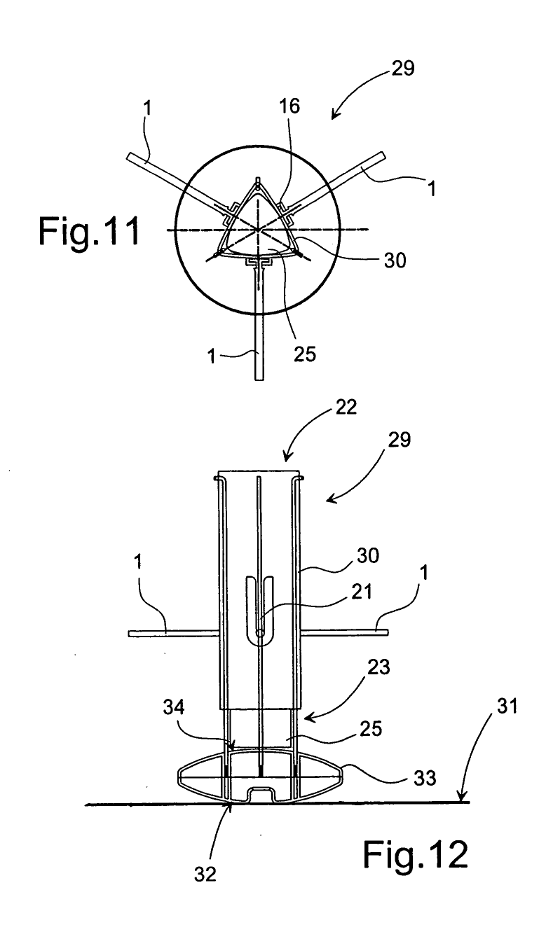

In FIGS. 11 and 12 are illustrated a further embodiment for a bite device 29 according to the invention. The bite device includes a triangular support 30 having internal shape 22 so as to accommodate a rod 25 of the feed supplement corresponding to the one shown in FIGS. 9 and 10. The support 30 is provided with grooves 21 at its three surfaces corresponding to FIG. 9 and 10.

The support 29 is intended for being placed on a floor 31 as it rests on a curved surface 32. The curved surface 32 is formed at the underside of a lens-shaped base part 33. At the upper side of the lens-shaped base part 33 there is a contact surface 34 upon which a rod 25 of feed supplement is resting. A part of the rod 25 will thus be exposed in the area 23 under the triangular support 30.

By this embodiment there is also provided a combined dispenser for minerals and support for bite rods 1. This model is intended to be mounted against a floor.

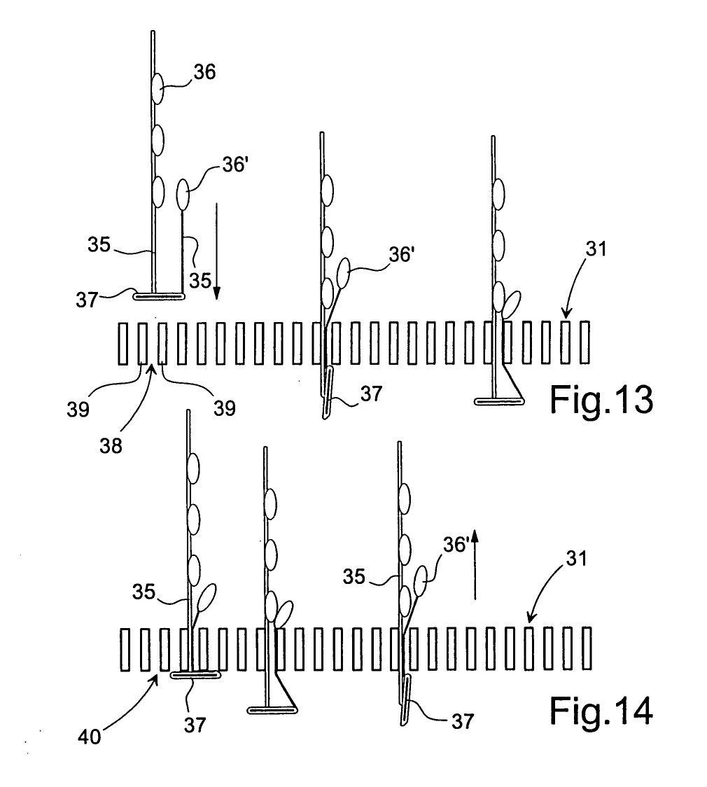

In order to prevent the bite device 29 from turning over when the animals are working with it, it is fitted to the floor 31 and dismounted therefrom as shown in FIGS. 13 and 14.

The mounting is effected by means of a rubber band 35 provided with enlarged parts 36. The rubber band 35 is connected via a plate 37 at the lower part. The plate 37 has a thickness so as to pass through an interspace 38 between two adjacent grate bars 39 in a slatted floor. At the mounting, the enlargement 36′ is pulled, after which the plate 37 under largely vertical orientation can be passed down through the interspace 38, as the rubber band 35 is tensioned simultaneously. By releasing the pull in the enlarged part 36′, the plate again assumes its horizontal shape due to an elastic connection between the plate 37 and the rubber band 35. When the rubber band is released, the plated 39 will come into abutment against the underside 40 of the grate bars 39. In this situation, tension is still present in the rubber band 35.

As the rubber band 35 is fastened at a central position in the base part 33, this is held in resilient abutment against the floor 31. Hereby, the support 30 will be self-righting when the animals push it from different sides. When dismounting, a downward pressure is exerted so that the plate 37 is in a position under the floor, as shown in the lower middle illustration. Then a pull is exerted in the enlarged part 36′. Then the plate 37 can be pulled up through the interspace 38 after which the support can be removed

It is noted, that the rubber bands 35 may be made of rubber in which is embedded members of metal, vinyl or other for providing the enlarged parts 3.6, 36′.

It is noted that the length or the height of the elements are shown as being rectilinear. However, the length of the means is not greater than they can lie within the lensshaped base part 33. It is noted that the lens-shaped base part 33 is bipartite. It is possible to separate the two parts which may be mutually connected by means of a bayonet socket of the same kind known from safety lids for bottles so that they may only be opened when a downward pressure and a mutual turning of the two parts are simultaneously performed. Hereby, access is provided to the interior and thereby the rubber band 35.

As alternative to the shown rubber band 35 there may be used spring-loaded hooks which can pass down between the slats and turned 90° in order for a hook part to become engaged under an adjacent grate bar. Other resilient fastenings will also be possible. However, it is just to be ensured that spring action is present for contributing to raise the support 29 to vertical position. If no resilient support was present, a very large diameter of the lens-shaped base 33 in order to ensure an automatic re-erection was required.

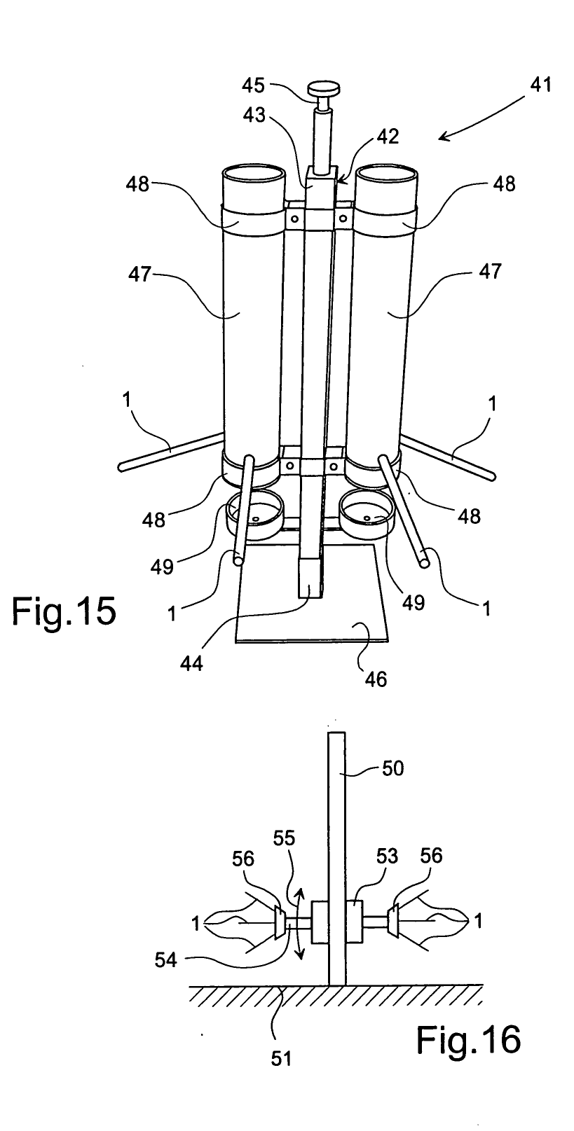

FIG. 15 shows an embodiment of a bite device 41 according to the invention. The bite device includes a central column 42 consisting of an external tube 43 and an internal tube 44, which are mutually telescoping and can be adjusted with an adjusting handle 45. The column 42 is disposed on a base plate 46 for mounting in a floor. In the shown embodiment, two opposite tubes 47 are supported by the column. The tubes 47 are fastened by means of upper and lower metal brackets of spring steel, which enable a resilient, flexible movement of the tubes 47 in relation to the column 42. Below each of the tubes there is fastened a bowl 49 intended for receiving pills and briquettes contained in the tubes 47 or for supporting a rod-shaped material contained in each of the tubes 47. The tubes 47 can contain minerals in pill or rod form, straw briquettes or feed. At the lower end of the tubes 47, there are disposed bite objects 1 of the kind described above.

The bite device illustrated in FIG. 15 is advantageous in providing a combined dispenser for bite objects, minerals, feed, straw briquettes etc. A plurality of tubes placed on the columns 42 may thus have different content.

In FIG. 16 there is illustrated a partitioning wall 50 mounted on the floor 51 between two sties. In the partitioning wall 50 there is fitted an elastic box 53, in which there is fastened a through-going tube 54, which may perform a spatial, resilient, yielding oscillation as indicated by the arrow 55. In each end of the tube there is provided a holder 56 supporting a number of bite objects 1 of the kind described above. When the animals are actuating the bite objects 1 in one sty, movement will be induced in the adjacent sty, increasing the interest for the bite objects in the adjacent sty.

As it appears from FIG. 17, a tube 57 is provided in a holder 58 fastened to the partitioning wall 50. Through the tube is running a chain 59 which at each end has a stop means 60 preventing the chain from being drawn through the tube. At the side of each of the stop means there is provided a holder 61 supporting the bite objects 1. In this way, the bite objects will be disposed in a swinging holder. Also, movement in bite objects in an adjacent sty is established when the animals use the bite objects in one end of such chain.

Other embodiments of the invention are possible as individual features from the above embodiments may be combined. Furthermore, it is possible that several sets of bite objects are disposed below each other, i.e. fastened to the support by circles superposed in horizontal planes.

1. A bite device for pigs and including a support carrying a number of oblong bite objects in the form of rods of tough plastic material projecting from the support and used by the pigs to find outlet for an urge that otherwise may be manifested in tail biting, characterised in that the support is arranged with a flexible mounting means for movement in relation to the point of fastening on ceiling, wall and floor, and that the support is arranged so that the bite objects are mounted at points along a horizontally extending circle.

2. A bite device according to claim 1, characterised in that the mounting means includes a wire, a chain or similar whereby the support is made pivoting.

3. A bite device according to claim 1, characterised in that the mounting means includes a resilient element whereby the support is resiliently movable.

4. A bite device according to claim 3, characterised in that the support includes a curved surface for bearing against wall or floor, and that the resilient element holds the support in resilient abutment against said wall or floor.

5. A bite device according to claim 2, characterised in that the points of suspension for respective bite objects are mutually spaced along a ring that may be suspended in horizontal position.

6. A bite device according to claim 2, characterised in that external shape of the support is a cone pointing downwards in suspended condition, the bite objects projecting inclining from the side of the cone.

7. A bite device according to claim 2, characterised in that the support is cylindric and that the bite objects are suspended at the lowermost rim of the support during use.

8. A bite device according to claim 6 or 7, characterised in that the interior of the support is provided with a moulded core of feed supplement for pigs, and that the side of the support is perforated so that pigs have access to the feed supplement and may eat it, and that the bite objects at least partly are made of feed supplement, preferably minerals.

9. A bite device according to any preceding claim, characterised in that each bite object is rod-shaped and provided with at least one longitudinal slit and with an annular groove along its periphery close to one end thereof.

10. A bite device according to claim 9, characterised in that the rod-shaped bite object mainly consists of a substantially S-shaped profile.
